(19) United States
(12) Patent Application Publication
(10) Pub. No.: US 2019/0387660 A1
(43) Pub. Date: Dec. 26, 2019

(54) SEED MAT FOR INSERTION INTO AN APPARATUS FOR GROWING PLANTS AND METHOD FOR PRODUCING THE SAME

(71) Applicant: Agrilution GmbH, Munich (DE)

(72) Inventors: Maximilian Loessl, Munich (DE); Philipp Wagner, Fuerstenfeldbruck (DE)

(21) Appl. No.: 16/446,675

(22) Filed: Jun. 20, 2019

(30) Foreign Application Priority Data
Jun. 21, 2018 (DE) 10 2018114954.9

(51) Int. Cl. A01C 1/04; A01G 24/22; A01G 24/48; A01G 24/44; G06K 19/04

(52) U.S. Cl. CPC A01C 1/042; A01G 24/22; G06K 19/045; A01G 24/44; A01G 24/48

(57) ABSTRACT

In various exemplary embodiments, a seed mat for insertion into an apparatus for growing plants is provided, wherein the seed mat includes a carrier substrate and seeds, wherein the seeds are fixed on the carrier substrate by means of an adhesive. Furthermore, a method for producing a seed mat in various exemplary embodiments may include: applying an adhesive on a carrier substrate; applying seeds on the carrier substrate provided with the adhesive; and fixing the seeds by the adhesive on the carrier substrate.

Various exemplary embodiments relate to a seed mat for growing plants, and to a method for producing the same.

In the field of the provision of fresh products such as for example herbs, salad, fruit and vegetables, consumer demands have grown to an increasing extent in recent years. In particular since the denunciation of abuses in the husbandry of animals for slaughter, and the increasing prevalence of vegetarian or vegan foods, the awareness of many consumers of fresh products, and their demand for these, has increased.

These products have hitherto for the most part been produced either on fields or in greenhouses of large industrial operations and brought to the consumers by being sold in supermarkets. To a lesser extent, the consumers also obtain a supply directly from the producer at weekly markets and from direct selling on farms, wherein these distribution channels are available only to a relatively small part of the population owing to the restricted time availability or the required spatial proximity to the producer.

With the increased awareness of large parts in particular of the urban population with regard to their own health, there is, specifically in this case, an increasingly growing demand for products from controlled cultivation, and even the desire for personal control and meaningful engagement in the cultivation of one's own, correspondingly fresh products.

However, only a very small part of the urban population has access to a garden or corresponding facilities in which, for example, they could set up their own small greenhouses in order to cultivate fresh products. Also, the urban environment seldom offers the possibility of handling planting boxes and pots without relatively great organizational effort, let alone providing the plants cultivated therein firstly with the required protection against weather influences and secondly with adequate sunlight in order to promote the desired growth of the plants.

Furthermore, specifically the urban population commonly has a daily routine involving working away from home and often long traveling distances to and from the workplace, such that there is no desire, aside from everything else, to also tend to the growth of plants, to monitor this growth, and to adapt the care of these plants to the respective growth phase.

Owing to all these difficulties, many people who would in fact gladly benefit from cultivating their own plants and harvesting their own products are put off by the effort that the cultivation of these plants entails. They are put off even more by the feeling that there is a very low likelihood that, after all the effort, fresh ingredients from one's own cultivation will in fact be worthwhile, because, in hectic urban everyday life, it is not possible to ensure care of the plants which is sufficiently optimal that it leads to good results.

In terms of the informed consumer who intentionally wishes to eat healthily and at the same time is intent on achieving sustainability but has neither the space nor the time to cultivate plants in the conventional manner, it is thus desirable to create a means with which even small consumers, such as, for example, the typical modern single urban resident, may independently supply themselves with fresh food ingredients to the desired extent.

In the context of these demands, an apparatus has recently been proposed with the aid of which even individual consumers can, on a small scale adapted to common kitchen sizes, grow fresh herbs, salads, vegetables or fruit (see DE 10 2015 118 059 A1).

Particular requirements when growing plants in such an apparatus are linked to the provision of the seeds. In this case, the consumer has to be provided with the seeds in such a way that the latter may be inserted into the apparatus without the consumer himself/herself having to apply the seed grains onto or into the planting substrate, without the consumer here having to handle soil or similar bulky planting substrates to a relatively great extent, and without dirt arising here to a relatively large degree. Moreover, seeds and substrate should be provided in dimensions or sizes or amounts such that the retail sector may stock appropriate amounts of seeds, transportation to the consumer is easily possible and the consumer may also store amounts commensurate with his/her individual budget.

In various exemplary embodiments, a seed mat for insertion into an apparatus for growing plants is provided, wherein the seed mat includes a carrier substrate and seeds, wherein the seeds are fixed on the carrier substrate by means of an adhesive.

The seed mat may be configured to the effect that the seeds fixed thereon germinates and plants grow therefrom.

In various exemplary embodiments, the carrier substrate is formed from one or more organic materials, from one or more inorganic materials, or a combination of one or more organic materials and one or more inorganic materials.

In various exemplary embodiments, the carrier substrate is formed, for example, from a material selected from a group consisting of jute, hemp, rock wool, mineral wool, wool, wool fiber, cotton, cellulose, viscose, felt, textile fiber, synthetic fibers, Eucalyptus Jiffy® Vitro-Plug™ or Oasis® Floral Foam.

In various exemplary embodiments, the adhesive is an organic adhesive. In this connection, the material of the adhesive is not restricted to organic materials, but may, for example, also consist of an inorganic adhesive.

In various exemplary embodiments, the adhesive is a starch-based adhesive. Alternatively, it is also possible to use, for example, cellulose or hydroxyethylcellulose (HEC) as an adhesive or adhesives based on these substances.

In various exemplary embodiments, the seeds may include, for example, seeds of salad, herbs, fruit and vegetables, such as tomatoes, and mushrooms or mushroom mycelia.

In various exemplary embodiments, the seed mat may furthermore include an RFID labelling and/or a QR labelling and/or a barcode.

In various exemplary embodiments, the RFID labelling and/or the QR labelling and/or the barcode encode(s) the seeds fixed on the seed mat.

An apparatus for growing plants may be configured to identify the seeds fixed on the seed mat by means of a program sensor of a program controller.

In various exemplary embodiments, the program sensor may be configured as an RFID sensor and/or a QR code sensor and/or a barcode sensor and may be configured to detect RFID signals of the RFID labelling and/or the QR labelling and/or the barcode of at least one seed mat inserted into an accommodating space of the apparatus for controlling the program controller.

The program controller may include, for example, climate control data and/or irrigation data and/or illumination data adapted individually to seeds accommodated in the accommodating space.

A data memory, from which the climate control data and/or irrigation data and/or illumination data adapted individually to the seeds are retrievable, may be provided for the program controller. The data memory may be provided as an external data memory, for example, by way of an Internet connection provided in the apparatus.

In various exemplary embodiments, the RFID labelling may be embodied as an RFID chip.

The RFID chip may have, for example, data regarding the seeds fixed on the seed mat. Moreover, the RFID chip may have, for example, data regarding the seed mat. By way of example, the data stored on the RFID chip may include data concerning a name of the seeds, a type of the seeds, a species of the seeds, a manufacturer of the seeds, a BATCH number of the seeds, a year of manufacture of the seed mat and/or a registration number of the manufacturer and/or seller of the seed mats.

Furthermore, the data stored on the RFID chip may be data concerning climate control data and/or irrigation data and/or illumination data adapted individually to the seeds fixed on the seed mats.

The apparatus for growing plants may be configured, by means of the program controller on the basis of the climate control data in the accommodating space, to set an interior space climate adapted to the seeds fixed on the seed mat and/or to the plants growing on the seed mat.

By way of example, the apparatus for growing plants may be configured, by means of the program controller on the basis of the irrigation data of the seed mat, to supply water and nutrients in an amount and composition adapted to the seeds fixed on the seed mat and/or to the plants growing on the seed mat.

In addition, the apparatus for growing plants may be configured, for example, by means of the program controller controlling an illumination device, on the basis of the illumination data, to emit light with a wavelength composition adapted to the seeds fixed on the seed mat and/or to the plants growing on the seed mat, with an intensity adapted to the seeds fixed on the seed mat and/or to the plants growing on the seed mat, and for a duration adapted to the seeds fixed on the seed mat and/or to the plants growing on the seed mat.

In various exemplary embodiments, the RFID labelling and/or the QR labelling and/or the barcode may be configured to be separated from the seed mat.

The seed mat may be configured to be connected to a fertilizer mat.

Moreover, the seed mat may be configured to be stacked. By way of example, the seed mat may be configured to be stacked with the fertilizer mat.

In various exemplary embodiments, a method for producing a seed mat may include: applying an adhesive on a carrier substrate; applying seeds on the carrier substrate provided with the adhesive; and fixing the seeds by means of the adhesive on the carrier substrate.

In various exemplary embodiments, the seeds may be fixed on the carrier substrate in such a way that the seeds may germinate and plants may grow therefrom on the seed mat.

The carrier substrate may be formed, for example, from one or more organic materials. Alternatively, the carrier substrate may, for example, also be formed from one or more inorganic materials, or a combination of an organic material and an inorganic material.

In various exemplary embodiments, the carrier substrate may be formed, for example, from a material selected from a group consisting of jute, hemp, rock wool, mineral wool, wool, wool fiber, cotton, cellulose, viscose, felt, textile fiber, synthetic fibers, Eucalyptus Jiffy® Vitro-Plug™ or Oasis® Floral Foam.

In various exemplary embodiments, the adhesive may be an organic adhesive. In this connection, the material of the adhesive is not restricted to organic materials, but may, for example, also consist of an inorganic adhesive.

For example, the adhesive may be a starch-based adhesive. Alternatively, it is also possible to use, for example, cellulose or hydroxyethylcellulose (HEC) as an adhesive, or adhesives based on these substances.

In various exemplary embodiments, the seeds used may include, for example, seeds of salad, herbs, fruit and vegetables, such as tomatoes, and mushrooms or mushroom mycelia.

In various exemplary embodiments, applying the adhesive on the carrier substrate may include applying the adhesive on the carrier substrate by means of one or more rollers, applying the adhesive on the carrier substrate by means of a spraying system, or applying the adhesive on the carrier substrate by means of one or more brushes.

In various exemplary embodiments, applying seeds on the carrier substrate provided with the adhesive may include applying the seeds on the moist adhesive (for example on the moist carrier substrate), wherein the seeds consist of seed grains, and wherein the seed grains are scattered or individually placed precisely at a specific position.

The amount of moisture present in the adhesive and the moist carrier substrate, respectively, may be so low that the seeds do not begin to germinate.

In various exemplary embodiments, the adhesive or the carrier substrate may then be dried in the air and/or by means of heat and/or by means of an air flow.

In various exemplary embodiments, the method may furthermore include identifying the seed mat by means of an RFID labelling and/or a QR labelling and/or a barcode.

By way of example, the RFID labelling and/or the QR labelling and/or the barcode may encode the seeds fixed on the seed mat.

In various exemplary embodiments, the RFID labelling may be embodied as an RFID chip.

The RFID chip may include, for example, data regarding the seeds fixed on the seed mat. Moreover, the RFID chip may include, for example, data regarding the seed mat. The seed mat and/or the seeds fixed thereon are/is preferably identifiable biuniquely by means of the RFID chip.

By way of example, the data stored on the RFID chip may include data concerning a name of the seeds, a type of the seeds, a species of the seeds, a manufacturer of the seeds, a BATCH number of the seeds, a year of manufacture of the seed mat and/or a registration number of the manufacturer and/or of the seller of the seed mat.

Furthermore, the data stored on the RFID chip may additionally be, for example, data concerning climate control data and/or irrigation data and/or illumination data adapted individually to the seeds fixed on the seed mats.

In various exemplary embodiments, the method may furthermore include producing one or more fertilizer mats. Furthermore, the method may include connecting a respective seed mat to a respective fertilizer mat.

In various exemplary embodiments, the seed mats may be embodied as stackable. By way of example, the seed mats may be embodied as stackable with the fertilizer mats.

In various exemplary embodiments, a method for growing plants may include: producing one or more seed mats, as described above; introducing said one or more seed mats provided with seeds into an accommodating space of an apparatus for growing plants; and providing ambient conditions in such a way that the seeds on said one or more seed mats may germinate and plants may grow therefrom, by means of the apparatus.

In various exemplary embodiments, a method for growing plants may include: producing one or more seed mats as described above; providing first ambient conditions in such a way that the seeds on said one or more seed mats may germinate and plants may grow therefrom; interrupting the growth process by means of suitable second ambient conditions; introducing said one or more seed mats on which plants grow into an accommodating space of an apparatus for growing plants; and providing third ambient conditions, in such a way that the plants may continue to grow and bear fruit, if appropriate, by means of the apparatus.

By way of example, the ambient conditions may concern an air temperature, an air humidity, a water supply, a nutrient supply, an illumination quality, an illumination intensity and an illumination duration.

In various exemplary embodiments, the apparatus for growing plants may identify the seeds fixed on the seed mat by means of a program sensor of a program controller.

By way of example, the program sensor may be configured as an RFID sensor and/or a QR code sensor and/or a barcode sensor and may detect RFID signals of the RFID labelling and/or the QR labelling and/or the barcode of at least one seed mat inserted into the accommodating space of the apparatus for controlling the program controller.

In the method, the program controller may retrieve, for example, climate control data and/or irrigation data and/or illumination data adapted individually to the identified seeds from a data memory. The data memory may be provided, for example, as an external data memory. The program controller may retrieve the data, for example, by means of an Internet connection.

In various exemplary embodiments, the apparatus for growing plants may retrieve data concerning seeds fixed on the seed mat from an RFID chip attached to the seed mat. By way of example, the apparatus for growing plants may unambiguously identify the seed mat and/or the seeds fixed thereon, preferably by means of the RFID chip.

The RFID chip may include, for example, data regarding the seeds fixed on the seed mat. Furthermore, the RFID chip may include, for example, data regarding the seed mat.

By way of example, the data stored on the RFID chip may be data concerning a name of the seeds, a type of the seeds, a species of the seeds, a manufacturer of the seeds, a BATCH number of the seeds, a year of manufacture of the seed mat and/or a registration number of the manufacturer and/or of the seller of the seed mat.

Furthermore, the data stored on the RFID chip may be, for example, data concerning climate control data and/or irrigation data and/or illumination data adapted individually to the seeds fixed on the seed mats.

In the method, the apparatus for growing plants, for example, by means of the program controller, on the basis of the climate control data, may set an interior space climate in the accommodating space adapted to the seeds fixed on the seed mat and/or to the plants growing on the seed mat.

Moreover, the apparatus for growing plants, for example, by means of the program controller, on the basis of the irrigation data of the seed mat, may supply water and nutrients in an amount and composition adapted to the seeds fixed on the seed mat and/or to the plants growing on the seed mat.

Furthermore, the apparatus for growing plants, for example, by means of the program controller controlling an illumination device, on the basis of the illumination data, may emit light with a wavelength composition adapted to the seeds fixed on the seed mat and/or to the plants growing on the seed mat, with an intensity adapted to the seeds material fixed on the seed mat and/or to the plants growing on the seed mat, and for a duration adapted to the seeds fixed on the seed mat and/or to the plants growing on the seed mat.

Exemplary embodiments of the invention are illustrated in the figures and are explained in greater detail below. In the figures:

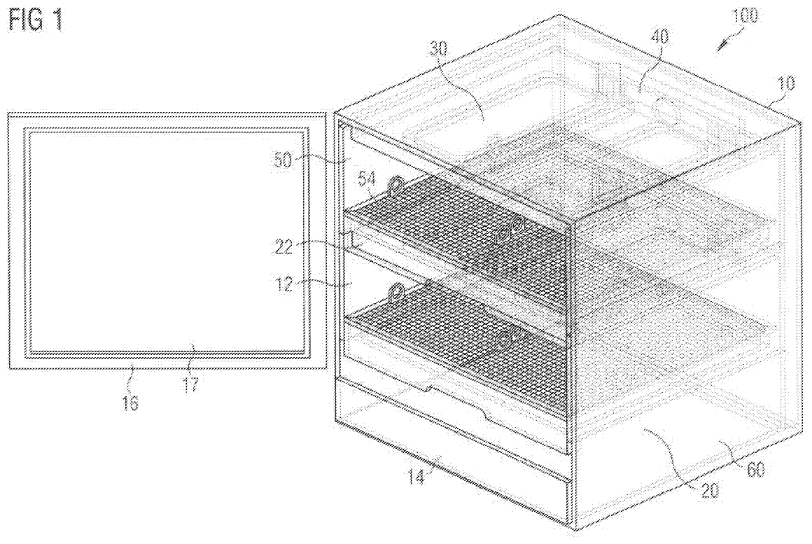

FIG. 1 shows an apparatus for growing plants, for inserting seed mats in accordance with various exemplary embodiments;

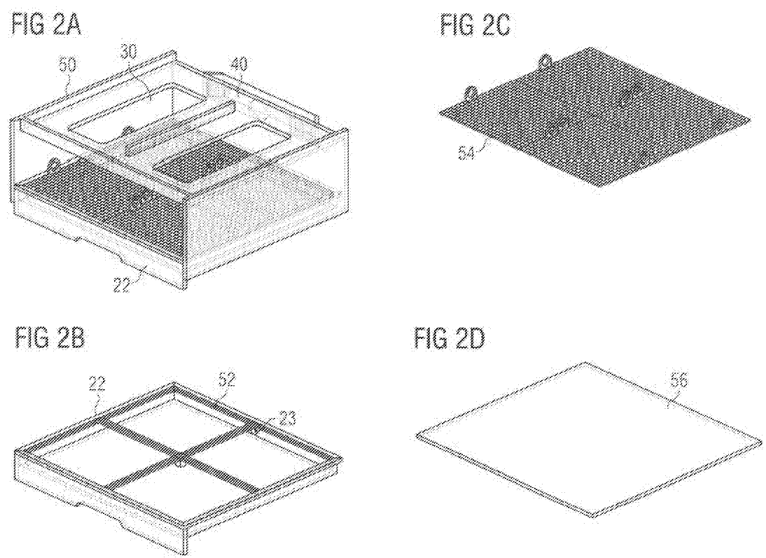

FIG. 2A shows a growing unit for inserting seed mats in accordance with various exemplary embodiments, into the accommodating space of the apparatus for growing plants;

FIG. 2B shows an irrigation trough of a growing unit;

FIG. 2C shows a mat carrier for insertion onto an irrigation trough and for placement of a seed mat in accordance with various exemplary embodiments;

FIG. 2D shows a seed mat in accordance with various exemplary embodiments, for placement onto a mat carrier;

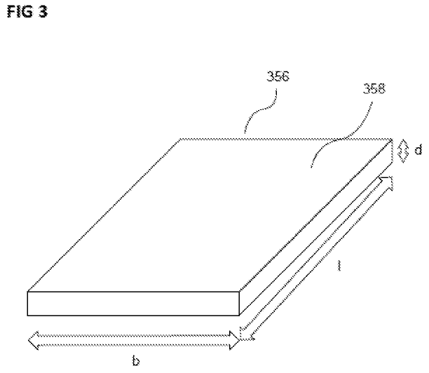

FIG. 3 shows a seed mat in accordance with various exemplary embodiments, for insertion into an apparatus for growing plants;

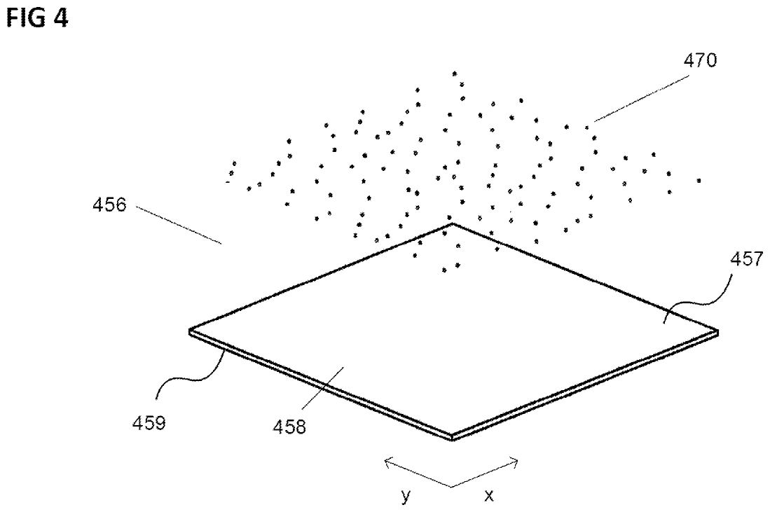

FIG. 4 shows a seed mat on which seeds are applied, in accordance with various exemplary embodiments;

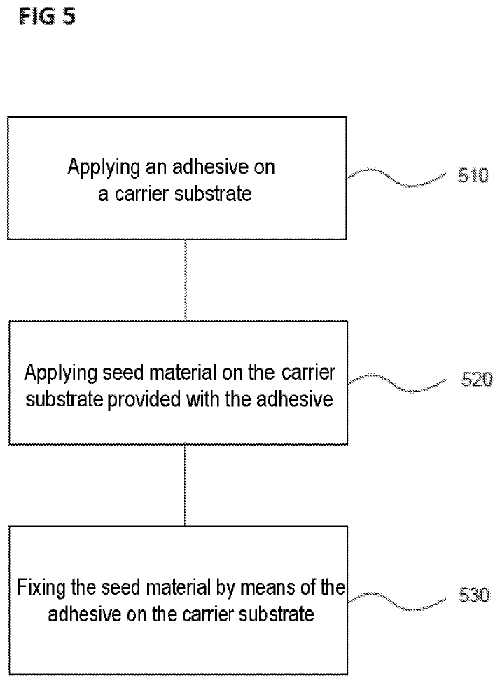

FIG. 5 shows a method for producing a seed mat in accordance with various exemplary embodiments;

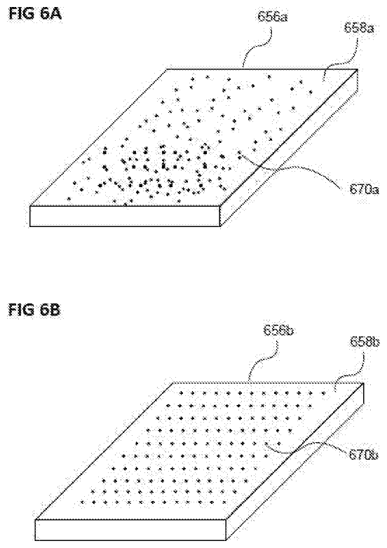

FIG. 6A and FIG. 6B show a seed mat with seeds in accordance with various exemplary embodiments;

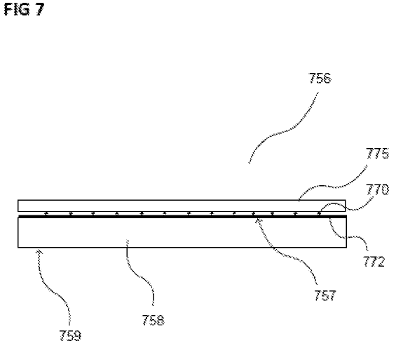

FIG. 7 shows a cross-sectional illustration of a seed mat on which seeds are applied, in accordance with various exemplary embodiments;

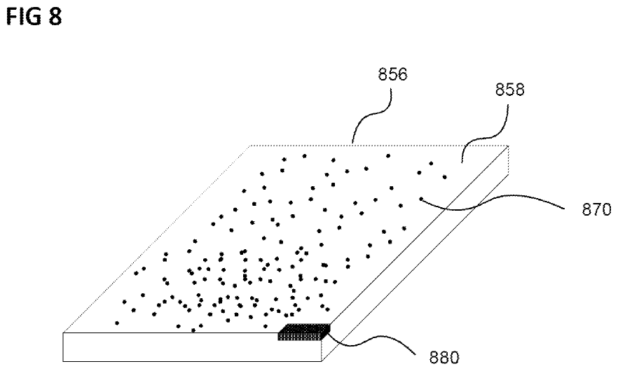

FIG. 8 shows a seed mat with an RFID labelling in accordance with various exemplary embodiments;

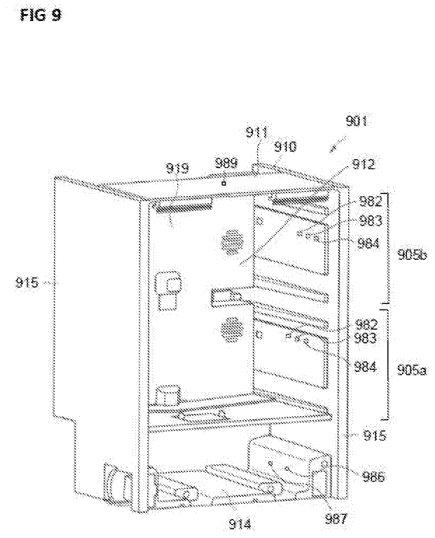

FIG. 9 shows an apparatus for growing plants for accommodating a seed mat in accordance with various exemplary embodiments.

In the following detailed description, reference is made to the accompanying drawings, which form part of this application and show specific embodiments in which the invention may be implemented for illustrative purposes. In this regard, directional terminology such as, for instance, “at the top”, “at the bottom”, “at the front”, “at the back”, “front”, “rear”, etc. is used with respect to the orientation of the figure(s) described. Since components of embodiments may be positioned in a number of different orientations, the directional terminology serves for illustrative purposes and is in no way restrictive. It goes without saying that other embodiments may be used and structural or logical modification may be made, without departing from the scope of protection of the present invention. It goes without saying that the features of the various exemplary embodiments described herein may be combined with one another, unless specifically indicated otherwise. Therefore, the following detailed description should not be interpreted in a restrictive sense, and the scope of protection of the present invention is defined by the appended claims.

In the context of this description, the terms “connected”, “attached”, and “coupled” are used to describe both a direct and an indirect connection, a direct or indirect attachment, and a direct or indirect coupling. In the figures, identical or similar elements are provided with identical reference signs where expedient.

An apparatus for growing plants for inserting seed mats in accordance with various exemplary embodiments is illustrated in FIG. 1.

As illustrated in FIG. 1, the apparatus for growing plants 1 may include a cabinet-like housing 10, which may be equipped with an accommodating space 12, an upper cover 11, a base 14 and a door 16, which may include an observation opening 17. Furthermore, the apparatus 1 may include an irrigation apparatus 20 and at least one illumination apparatus 30. Furthermore, a control unit 60 may be provided in the apparatus 1, which control unit may be accommodated, for example, in the base 14 of the apparatus 1, wherein the control unit 60 may drive the illumination apparatus 30 and the irrigation apparatus 20 by means of a program controller. Alternatively, the control unit 60 may be arranged in the upper cover 11 or on a rear side of the housing 10. Furthermore, the apparatus for growing plants 1 may include a climate control device 40, wherein the control unit 60 may also drive the climate control device 40 by means of the program controller.

Depending on the size of the apparatus 1, one or more growing units 50 of drawer-like form may be inserted into the accommodating space 12 of the apparatus for growing plants 1. The growing units 50 may each include an irrigation trough 22 and one or more mat carriers 54, and will be described with reference to FIG. 2A to FIG. 2D.

FIG. 2A shows a growing unit for the insertion of seed mats according to various exemplary embodiments into the accommodating space of the apparatus for growing plants. FIG. 2B shows an irrigation trough of a growing unit. FIG. 2C shows a mat carrier for insertion onto an irrigation trough and for placement of a seed mat in accordance with various exemplary embodiments. FIG. 2D shows a seed mat in accordance with various exemplary embodiments for placement onto a mat carrier.

As illustrated in FIG. 2A, each growing unit 50 may consist of an irrigation trough 22 with the associated illumination apparatus 30 arranged thereabove. In this case, each growing unit 50 may define a storey, as it were, into which seeds and plants may be inserted into the accommodating space 12 of the apparatus and grown there. For this purpose, as illustrated in FIG. 2B, each of the irrigation troughs 22 may have a preferably subdivided frame-like structure which may form one to four placement openings 52. One to four mat carriers 54 (FIG. 2C) of different sizes may be placed onto the frame-like structure of the placement openings 52, which mat carriers may in turn be equipped with corresponding seed mats 56 (FIG. 2D). In addition, each irrigation trough 22 may include a water inlet and outlet 23.

FIG. 3 shows a seed mat in accordance with various exemplary embodiments, for insertion into an apparatus for growing plants.

As illustrated in FIG. 3, the seed mat 356 may be substantially cuboid. In this connection, the seed mat 356 may have a width b in a range of approximately 20 mm to approximately 500 mm, optionally in a range of approximately 100 mm to approximately 300 mm, optionally in a range of approximately 180 mm to approximately 200 mm. Furthermore, the seed mat 356 may have a length l in a range of approximately 20 mm to approximately 500 mm, optionally in a range of approximately 150 mm to approximately 350 mm, optionally in a range of approximately 200 mm to approximately 250 mm. Furthermore, the seed mat 356 may have a thickness d in a range of approximately 1 mm to approximately 40 mm, optionally in a range of approximately 1 mm to approximately 20 mm, optionally in a range of approximately 1 mm to approximately 5 mm. In this case, however, depending on the intended dimensions of the apparatus for growing plants 1, the growing units 50 used therein, the placement openings 52 and/or the mat carriers 54 used, and depending on what types of plants are intended to be cultivated in the respective growing unit 50, the seed mat 356 may also have different dimensions than those indicated here for the length l, the width b and the thickness d.

The seed mat 356 may furthermore include a carrier substrate 358 and may be configured to fix seeds (not illustrated) on the carrier substrate 358 by means of an adhesive (not illustrated). Moreover, the seed mat 356 may be configured to the effect that the seeds fixed thereon may germinate and plants may grow therefrom on the seed mat 356. For this purpose, the carrier substrate 358 of the seed mat 356 may be formed from one or more organic materials, from one or more inorganic materials, or a combination of one or more organic materials and one or more inorganic materials. By way of example, the carrier substrate 358 may be formed from a material selected from a group consisting of jute, hemp, rock wool, mineral wool, wool, wool fiber, cotton, cellulose, viscose, felt, textile fiber, synthetic fibers, Eucalyptus Jiffy® Vitro-Plug™ or Oasis® Floral Foam.

With the use of a fibrous material for the carrier substrate 358 of the seed mat 356, the fibers may be interwoven or felted or pressed together, wherein the material preferably includes no adhesive for adhesively bonding the fibers. Depending on the required stability of the seed mat 356, however, the material of the carrier substrate 358 may also include an adhesive, wherein an organic adhesive is preferred. In this connection, the material of the adhesive is not restricted to organic materials, but may, for example, also consist of an inorganic adhesive.

Here, the carrier substrate 358 has specific properties, for example regarding its water absorption capacity and regarding its light transmissivity. By way of example, the carrier substrate 358 may have a water absorption capacity having a magnitude such that seeds fixed on the carrier substrate 358 may germinate. The water absorption capacity of the carrier substrate 358, for example of a mat composed of the carrier substrate 358 with a thickness of approximately 5 mm, may be, for example, in a range of approximately 3000 cm³ to approximately 6000 cm³ per square meter, for example in a range of approximately 3500 cm³ to approximately 5000 cm³ per square meter, for example in a range of approximately 4000 cm³ to approximately 4500 cm³ per square meter.

Moreover, the carrier substrate 358 or the seed mat 356 may have a light transmissivity (also referred to hereinafter as transmittance of the seed mat 356 or of the carrier substrate 358) which is in a range of approximately 0% to approximately 60%, optionally in a range of approximately 0% to approximately 40%, optionally in a range of 0% to approximately 20%, optionally in a range of approximately 0% to approximately 10%. In this case, the light transmissivity of the seed mat 356 should be low in order that as little light as possible is incident in the space below the mat carrier 54 (see FIG. 2) in the irrigation trough 22 of the growing unit 50, since light incident in this space would promote the growth of algae in the water supplied to the seeds and/or the plants growing therefrom by means of the irrigation apparatus 20.

Here, the light transmissivity of the seed mat 356 or of the carrier substrate 358 may be the median of the transmittance of the seed mat 356 determined for example at five or any other desired number of measurement points arranged at a distance from one another and distributed uniformly over the area l×b of the seed mat 356, at which measurement points the transmittance of the material used for the carrier substrate 358 in the direction of the thickness d of the seed mat 356 is determined by means of irradiating the seed mat 356 with light. In this case, the transmittance of the material is determined, for example, using a conventional photometer (for example a lux meter). Preferably, light of the illuminant CIE-D65 (for example according to ISO 13468) is used here. However, determining the transmittance of the carrier substrate 358 or of the seed mat 356 is not restricted to the procedure described here.

It is to be noted that, in various exemplary embodiments, elements, component parts, materials, effects, dimensions, distances, etc. of apparatuses or parts thereof which are described in association with FIG. 1 to FIG. 9 may correspond to those which are described in association with other figures. The same holds true with regard to elements, component parts, materials, effects, dimensions, distances, etc. of apparatuses or parts thereof which are presented and explained in association with FIG. 1 to FIG. 9, for exemplary embodiments described with reference to any of the other figures. A repetition may therefore be omitted, and the elements, component parts, materials, effects, dimensions, distances, etc. may be provided with the same reference signs. It should furthermore be taken into consideration that the list of the mentioned materials of all elements described is not exhaustive, but further materials may be used if their use is expedient.

In particular, it is to be noted that the materials, size indications and/or properties of the seed mat 356 as described above in association with FIG. 3 also hold true for other exemplary embodiments of the seed mat which are described above and below in association with other figures (for example in association with the seed mat 56 in FIG. 1 and FIG. 2), even if this is not expressly mentioned individually. This holds true in the context of the entire description, insofar as additional and/or alternative indications are not expressly given with regard to a material used, a size indication used and/or properties of these materials used.

FIG. 4 shows a seed mat on which seeds are applied, in accordance with various exemplary embodiments. FIG. 5 shows a method for producing a seed mat in accordance with various exemplary embodiments.

As illustrated in FIG. 4, a carrier substrate 458 of a seed mat 456 has a top side 457 and a bottom side 459. Seeds 470 may be applied on the carrier substrate 458 of the seed mat 456. By way of example, seeds 470 may be applied on the top side 457 of the carrier substrate 458.

As illustrated in FIG. 5, a method of producing a seed mat includes applying an adhesive on a carrier substrate, 510, applying seeds on the carrier substrate provided with the adhesive, 520, and fixing the seeds by means of the adhesive on the carrier substrate, 530. In this case, in the method of producing a seed mat, the adhesive (not illustrated in FIG. 4) may be applied on the top side 457 of the carrier substrate 458 of the seed mat 456. Accordingly, the seeds 470 may be applied on the top side 457 of the carrier substrate 458, said top side having been provided with the adhesive, and may be fixed by means of the adhesive on the top side 457 of the carrier substrate 458.

In this case, the seeds, for example the seeds 470 illustrated in FIG. 4, in accordance with various exemplary embodiments of the method, are fixed on the carrier substrate, for example the carrier substrate 458, for example on the top side 457 of the carrier substrate 458, in such a way that the seeds 470 may germinate and plants may grow therefrom on the seed mat 456.

The carrier substrate is formed for example from one or more organic materials, from one or more inorganic materials, or a combination of one or more organic materials and one or more inorganic materials. By way of example, the carrier substrate 458 is formed from a material selected from a group consisting of jute, hemp, rock wool, mineral wool, wool, wool fiber, cotton, cellulose, viscose, felt, textile fiber, synthetic fibers, Eucalyptus Jiffy® Vitro-Plug™ or Oasis® Floral Foam, wherein the selection of the material for the carrier substrate 458 is not restricted thereto.

When selecting a suitable material for the carrier substrate, attention should be paid to ensuring that the material used alters the pH of the water in the irrigation device by not more than ±1 and alters the conductance of the water in the irrigation device by not more than ±500 μS. Moreover, the material for the carrier substrate is preferably compatible with foodstuffs, as are all other materials used for the seed mat. Furthermore, the material used for the seed mats may preferably absorb water, wherein preferably at the same time it maintains its structure over a period of at least four weeks even in the wet or moist state. Furthermore, the seed mat material is preferably biodegradable.

In this case, as already explained above in association with FIG. 3, the seed mat 456 (or the carrier substrate 458 of the seed mat 456) may have a width b (not illustrated in FIG. 4) in a range of approximately 20 mm to approximately 500 mm, optionally in a range of approximately 100 mm to approximately 300 mm, optionally in a range of approximately 180 mm to approximately 200 mm. Furthermore, the seed mat 456 (or the carrier substrate 458 of the seed mat 456) may have a length l (not illustrated in FIG. 4) in a range of approximately 20 mm to approximately 500 mm, optionally in a range of approximately 150 mm to approximately 350 mm, optionally in a range of approximately 200 mm to approximately 250 mm. Furthermore, the seed mat 456 (or the carrier substrate 458 of the seed mat 456) may have a thickness d (not illustrated in FIG. 4) in a range of approximately 1 mm to approximately 40 mm, optionally in a range of approximately 1.5 mm to approximately 20 mm, optionally in a range of approximately 2 mm to approximately 5 mm. In this case, however, depending on the intended dimensions of the apparatus for growing plants 1, the growing units 50 used therein, the placement openings 52 and/or the mat carriers 54 used, and depending on what types of plants are intended to be cultivated in the respective growing unit 50, the seed mat 456 (or the carrier substrate 458 of the seed mat 456) may also have different dimensions than those indicated here for the length l, the width b, and the thickness d.

As adhesive (not illustrated in FIG. 4) for fixing the seeds 470 on the carrier substrate 458, it is possible to use an organic adhesive, for example, but the adhesive is not restricted thereto, but it is also possible to use an inorganic adhesive. The adhesive used for fixing the seeds 470 on the carrier substrate 458 is preferably water-soluble. This may be a starch-based adhesive, for example, but it is also possible to use other suitable materials which do not have an unfavorable influence on the germination of the seeds 470 on the seed mat 456. By way of example, alternatively, it is also possible to use cellulose or hydroxyethylcellulose (HEC) as adhesive or adhesives based on these substances for fixing the seeds 470 on the carrier substrate 458. The adhesive used for fixing the seeds 470 on the carrier substrate 458 may furthermore include, for example, plant-specific nutrients and/or minerals and/or plant hormones that encourage root growth (for example phytohormones) and/or other substances that encourage growth of the roots and the plants, such as, for example, organic and/or synthetic auxins.

In the method for producing a seed mat 56, 456, the adhesive may be applied on the carrier substrate 458 by means of various methods. By way of example, in accordance with one exemplary embodiment of the method, the adhesive may be applied on the carrier substrate 458 by means of one or more rollers. Alternatively, in further exemplary embodiments, the adhesive may be applied on the carrier substrate 458 for example by means of a spraying system or by means of one or more brushes. In this case, an organic adhesive may be used as adhesive. By way of example, a starch- or cellulose-based adhesive may be used as adhesive for fixing the seeds 470 on the carrier substrate 458. In this case, the material of the adhesive is not restricted to organic materials, but rather may for example also consist of an inorganic adhesive.

In the method for producing a seed mat 56, 456, the adhesive may be applied in a laminar manner on the entire surface 457 of the carrier substrate 458 or may be applied at defined locations of the surface 457 of the carrier substrate 458 in a punctiform manner and/or in a specific volume (for example adapted to the size of the seeds 470 to be placed there).

By means of applying the adhesive to the carrier substrate 458, the latter is moistened somewhat. In this case, however, the carrier substrate 458 should include an amount of moisture that is so low that the seeds do not begin to germinate. In other words, the amount of moisture present in the adhesive or in the carrier substrate 458 should be so low that the seeds do not begin to germinate.

It should be noted that the adhesive need not always be applied on the carrier substrate 458. The adhesive may also be omitted depending on the material constitution of the carrier substrate 458 and the type of seeds 470 to be arranged thereon.

After applying the adhesive on the carrier substrate 458, in the method for producing a seed mat 56, 456, applying seeds may include applying the seeds 470 on the moist adhesive or the moist carrier substrate 458. In this case, the seeds 470 may consist of seeds or seed grains or grains of seeds, for example, wherein the seeds or seed grains or grains of seeds may be scattered or individually placed precisely at a specific position (see also FIG. 6). By way of example, the individual seed grains of the seeds 470 may be applied on the seed mat 456 at an average distance from one another in a range of approximately 0.5 mm to approximately 50 mm, optionally in a range of approximately 2 mm to approximately 35 mm, optionally in a range of approximately 5 mm to approximately 25 mm. In this case, depending on the type of the desired plant, the seed grains have an average diameter in a range of approximately 0.5 mm to approximately 10 mm, optionally in a range of approximately 1 mm to approximately 6 mm.

If the seed grains of the seeds 470 are scattered on the carrier substrate 458 over a large area, they may be distributed irregularly on the carrier substrate 458, wherein regions of the carrier substrate 458 may have a higher density and other regions of the carrier substrate 458 a lower density of grains of seeds. In this case, the density of the grains of seeds, in other words, the average distance between the seed grains, may be set by means of the amount of seeds 470 applied, for example scattered, over a defined area of the carrier substrate 458.

In the case where the seed grains of the seeds 470 are placed in a targeted manner, it is possible to set the distances between the seed grains in an x-direction of the seed mat 456 and in a y-direction of the seed mat 456. If appropriate, it is also possible to arrange just a single seed grain on a seed mat 56, 456, for example in the case of relatively small, rather cubic seed mats 56, 456 and when sowing plants having a relatively large space requirement.

In various embodiments, by way of example, seeds of salad, herbs, fruit and vegetables and mycelia of edible mushrooms may be used as seeds 470. Plants whose seeds may be applied on the carrier substrate 458 for the purpose of growing in the apparatus for growing plants are, for example, arugula, various cresses, various leaf salads (e.g. oakleaf lettuce, corn salad, lollo types, and others, but also so-called baby leaf salads of various leaf salads), rocket (Eruca), mangold, beetroot, various varieties of cabbages (Brassica), leaf mustard (Tatsoi), various types of basil (Ocimum), coriander, dill (Anethum), parsley (Petroselinum), carrots (Daucus), radish (Raphanus) and other root vegetables, micro-greens (young, small-leaved leafy vegetables), various types of baby herbs and baby vegetables, dwarf tomatoes, strawberries and mycelia or spores of edible mushrooms. It should be noted that this list is not exhaustive and seeds of further plant types, for example plant types usable for medical purposes or other purposes, which do not grow too large before consumption of the edible plant parts or use of the plant parts to be used, and mycelia or spores of various edible mushrooms may be applied on the carrier substrate 458 for growth in the apparatus.

In various exemplary embodiments, relatively small seeds 470 having an average diameter of the seeds of up to approximately 3 mm is better suited for cuboid seed mats 456 having an area (b×l) in a format in a range of approximately (150 mm×250 mm), optionally in a range of approximately (180 mm×235 mm), with a thickness d in a range of approximately 1 mm to approximately 10 mm, optionally in a range of approximately 2 mm to approximately 5 mm, optionally in a range of approximately 3 mm to approximately 4 mm, but is not restricted thereto. Relatively large seeds 470 having an average diameter of the seeds in a range of approximately 3 mm to approximately 10 mm is better suited for relatively thick cuboid seed mats 456 having an area (b×l) in a format in a range of approximately (150 mm×250 mm), optionally in a range of approximately (80 mm×100 mm), optionally in a range of approximately (30 mm×50 mm), with a thickness d in a range of approximately 3 mm to approximately 50 mm, optionally in a range of approximately 10 mm to approximately 40 mm, optionally in a range of approximately 15 mm to approximately 30 mm, or cubic seed mats 456 in a format of approximately (30 mm×30 mm) with a thickness d of approximately 30 mm, but is not restricted thereto. In this case, relatively large seeds of the seeds 470 having an average diameter in a range of approximately 3 mm to approximately 10 mm may be applied individually or in a small number of approximately 1 to approximately 5 grains of seeds on a cubic seed mat 456.

In various exemplary embodiments, seeds of different plants may be applied on a single seed mat 456. In other words, mixed seeds of different plants together, in other words in a mixture, may be fixed together onto a seed mat 456. In particular, for example different species of one genus, for example red and green basil of the genus Ocimum, or even different species of different genera, for example different salad types (e.g. leaf mustard, arugula and Tatsoi) or herbs (e.g. Thai basil and coriander), may be fixed together onto a seed mat 456.

When cultivating edible mushrooms, alternatively, it is also possible to apply mushroom mycelia or mushroom spores onto the carrier substrate 458. For this purpose, the carrier substrate 458 may likewise be prepared with an adhesive and/or moisture before the mushroom mycelia or the mushroom spores are applied onto the carrier substrate 458.

Afterward, the carrier substrate 458 with the seeds 470 applied thereon and/or the mushroom mycelium applied thereon may be dried. The drying of the carrier substrate 458 and/or of the adhesive on the carrier substrate 458 may be carried out simply in the air and/or may be accelerated by means of heat and/or by means of an air flow.

In various exemplary embodiments, the seeds 470 may additionally be fixed on the seed mat 456 by means of applying a thin coating layer (not illustrated; see FIG. 7) above the seeds 470. Particularly when applying relatively large seeds 470 having an average diameter, for example, in the range of approximately 3 mm to approximately 10 mm, it may be helpful to additionally fix or secure said seeds on the carrier substrate 458 by means of the coating layer. In this case, the coating layer may increase the pressure with which the seed grains are fixed onto the carrier substrate 458, as a result of which, moreover, the contact area of the seeds 470 on the carrier substrate 458 is increased by comparison with a state without additional fixing by means of a coating layer. This may have the effect that moisture surrounding an individual seed grain upon the moistening of the seed mat 456, for example during germination, is increased by comparison with a state without the coating layer, which may have a favorable influence on the germination process. When applying relatively small seeds 470 having an average diameter, for example, in the range of approximately 1 mm to approximately 3 mm, the coating layer may usually be omitted. However, applying the coating layer may also be implemented when using the relatively small seeds 470 and may also be omitted when using the relatively large seeds 470 if this appears to be expedient in each case for other reasons.

It is to be noted that the adhesive may be omitted depending on the type of the seeds 470 sown and the material properties of the carrier substrate 458. Particularly with the use of a coating layer, it may not be necessary to provide the carrier substrate 458 with the adhesive. However, seeds 470 may also be arranged on the carrier substrate 458 without an adhesive and/or a coating layer being used.

In the method for producing the seed mat 456, the carrier substrate 458 may be provided with the adhesive, the seeds 470 and/or the coating layer as long as the carrier substrate 458 is still present in a larger format than the subsequently desired size of the seed mat 456. By way of example, the carrier substrate 458 may be produced with a long length and/or with a large width and be stored in rolled-up form. Before the adhesive is applied on the carrier substrate 458, by way of example, a relatively long piece of the carrier substrate roll may be unrolled. Afterward, the adhesive and the seeds 470 may be applied in a desired manner on the carrier substrate 458, which may subsequently be dried and then cut to the size of the seed mats 456 that is desired for delivery to the customer.

FIG. 6A and FIG. 6B each show a seed mat with seeds in accordance with various exemplary embodiments.

As illustrated in FIG. 6A, a seed mat 656a may include a carrier substrate 658a, on which seeds 670a are fixed, wherein the seed grains of the seeds 670a are distributed over the carrier substrate 658a in such a way that the seed grains are distributed irregularly thereon. In other words, the seed mat 656a may have at least one area in which the grains of seeds of the seeds 670a are close together (in other words, at a small distance from one another), and may have at least one area in which the grains of seeds of the seeds 670a are less close to one another (in other words, at a greater distance from one another). In this case, the distance between the grains of seeds is, for example, in a range of approximately 1 mm to approximately 200 mm, preferably in a range of approximately 5 mm to approximately 100 mm, preferably in a range of approximately 10 mm to approximately 50 mm. For this purpose, in the method for producing the seed mat 656a, the seed grains of the seeds 670a may be scattered in an unordered fashion over the carrier substrate 658a and be fixed thereon in this way.

As illustrated in FIG. 6B, as an alternative thereto, a seed mat 656b may include a carrier substrate 658b, on which seeds 670b are fixed, wherein the seeds of the seeds 670b are distributed over the carrier substrate 658b in such a way that the grains of seeds lie individually at a specific position. In other words, the seed mat 656b has at least one area in which the seed grains are arranged regularly at a distance from one another. In this case, the distance between the grains of seeds may be, for example, in a range of approximately 1 mm to approximately 200 mm, preferably in a range of approximately 5 mm to approximately 100 mm, preferably in a range of approximately 10 mm to approximately 50 mm. As an alternative thereto, the seed mat 656b may also have different areas in which the seed grains are distributed in different regular arrangements, for example a first area, in which the seeds are arranged close together, at regular distances from one another, and a second area, in which the seeds are arranged at larger regular distances from one another than in the first area (not illustrated). In order to produce a seed mat 656b as illustrated in FIG. 6B, in the method for producing the seed mat 656b, the seed grains of the seeds 670b may be individually placed precisely at a specific position of the carrier substrate 658b.

It should be noted that for the sake of simplicity in the illustration in FIG. 6A and FIG. 6B, an adhesive applied on the carrier substrate 658a, 658b for the purpose of fixing the seeds 670a, 670b in some exemplary embodiments of the seed mats 656a, 656b is not illustrated. It should likewise be noted that the seed mats 656a, 656b described with reference to FIG. 6A and FIG. 6B may have the configurations described with reference to any of the previous figures, FIG. 1 to FIG. 5. By way of example, the configurations of the seed mats 656a, 656b with regard to size, thickness, materials and arrangements of the constituents may be the same as for the seed mat 356 described above with reference to FIG. 3 and are not repeated here. Likewise, further possibilities for configuration of the seed mats 656a, 656b as described below with reference to FIG. 7 and FIG. 8 are possible, and the seed mats 656a, 656b are not restricted to the illustrations chosen here.

FIG. 7 shows a cross-sectional illustration of a seed mat on which seeds are applied, in accordance with various exemplary embodiments.

As illustrated in FIG. 7, a seed mat 756 may include a carrier material 758, on the top side 757 of which seeds 770 are applied. In this case, the seeds may be fixed on the top side 757 of the carrier material 758 by means of an adhesive 772. Furthermore, the seed mat 756 may include a coating layer 775 arranged above the seeds 770. In various exemplary embodiments, the seeds 770 may alternatively be fixed on the carrier substrate 758 by means of the coating layer 775 in such a way that the adhesive 772 between the carrier material 758 and the seeds 770 may be omitted. Moreover, the coating layer 775 itself may have an adhesive (not illustrated) that fixes the seeds 770 on the carrier substrate 758. In further exemplary embodiments, the seed mat 756 may also include only the carrier substrate 758 and the seeds 770, wherein both the adhesive 772 and the coating layer 775 may be omitted.

In various exemplary embodiments of a seed mat, the seeds 770 may additionally be fixed on the seed mat 756 by means of the thin coating layer 775 above the seeds 770. Accordingly, in the method for producing a seed mat, in various exemplary embodiments, the seeds 770 may additionally be fixed on the carrier substrate 758 by means of applying the thin coating layer 775 above the seeds 770.

The coating layer 775 may have a thickness in a range of approximately 0.05 mm to approximately 0.5 mm, optionally in a range of approximately 0.06 mm to approximately 0.3 mm, optionally in a range of approximately 0.07 mm to approximately 0.1 mm. The coating layer 775 may be formed from cellulose, for example, but is not restricted thereto. By way of example, the coating layer 775 may also be formed from pulp or other organic materials which may be produced with the small thickness mentioned in a suitable manner. Alternatively, in the method for producing a seed mat, the coating layer 775 may be formed by liquid cellulose, for example in the form of hydroxy ethylcellulose (HEC), being applied on the carrier substrate 758 having the seeds 770 such that, after drying, a very thin layer of cellulose remains and fixes the seeds 770 on the carrier substrate 658.

As already set forth above with reference to FIG. 4, it may be helpful, particularly when applying relatively large seeds 770 having an average diameter, for example, in the range of approximately 3 mm to approximately 10 mm, to fix or secure said seeds on the carrier substrate 758 by means of the coating layer 775. In this case, the coating layer 775 may increase the pressure with which the seed grains are fixed on the carrier substrate 758, as a result of which, moreover, the coating area of the seeds 770 on the carrier substrate 758 is increased by comparison with a state without additional fixing by means of the coating layer 775. This may have the effect that moisture surrounding an individual seed grain upon the moistening of the seed mat 756, for example during germination, is increased by comparison with a state without the coating layer 775, which may have a favorable influence on the germination process. When applying relatively small seeds 770 having an average diameter for example in the range of approximately 1 mm to approximately 3 mm, the coating layer 775 may usually be omitted. However, applying the coating layer 775 may also be implemented when using the relatively small seeds 770 and may also be omitted when using the relatively large seeds 770 if this appears to be expedient for other reasons.

In various exemplary embodiments, the coating layer 775 may be embodied in such a way that it covers the entire upper surface 757 of the carrier substrate 758 of the seed mat 756, as illustrated in FIG. 7. Alternatively, in various exemplary embodiments, the coating layer 775 may also be embodied such that it covers only a part of the upper surface 757 of the carrier substrate 758 (not illustrated).

In FIG. 7, the seeds 770 on the seed mat 756 are illustrated at regular distances from one another for the sake of simplicity in the illustration. However, the seed mat 756 is not restricted thereto, but the seeds 770 may also be arranged on the carrier substrate 758 irregularly or at different regular distances, as described above with reference to FIG. 6A and FIG. 6B.

It should be noted that the materials, sizes, thicknesses and arrangements suitable for the seed mat 756 and the constituents thereof may be the same as those described above with reference to any of FIG. 3 to FIG. 6, and are not repeated here.

In various exemplary embodiments, the seed mat 756 may be connected to a fertilizer mat (not illustrated). In other words, the seed mat 756 may be configured to be connected to a fertilizer mat. By way of example, a fertilizer mat may be arranged on a bottom side 759 of the carrier substrate 758. In this case, the fertilizer mat may be secured on the bottom side 759 of the carrier substrate. By way of example, the fertilizer mat may be connected to the carrier substrate 758 using an adhesive, such as, for example, a starch- or cellulose-based adhesive. Alternatively, the fertilizer mat may be secured to the carrier substrate 758 by means of sewing, stapling, tacking or some other suitable manner of securing. Materials compatible with foodstuffs (so-called “food safe” materials) are preferably used in this case.

The fertilizer mat may include a fertilizer substance. By way of example, the fertilizer mat may be impregnated with the fertilizer substance or may be coated with the fertilizer substance. Alternatively, the fertilizer substance may also be applied directly on the seed mat 756. In this case, the fertilizer substance used may be a liquid fertilizer substance, for example, which may be applied on the carrier substance 758 by means of rolling, spraying or using brushes. In this case, the fertilizer substance may be embodied in such a way that the fertilizer may be taken up by the roots of the plants growing on the seed mat 756. By way of example, in one exemplary embodiment, the fertilizer may dissolve in the water supplied to the irrigation trough and may thereby pass into the water circuit for the irrigation of the plants accommodated in the apparatus, wherein the fertilizer is pumped again to the roots of the plants growing on the carrier substrate 758 in each irrigation cycle.

The seed mat 756 may be shaped such that it is stackable. In other words, the seed mat 756 may be configured to be stacked. Furthermore, the seed mat 756 may be configured to be stacked with the fertilizer mat.

The seed mat 756 in accordance with the exemplary embodiments described herein may be configured to be placed onto a mat carrier 54 (see FIG. 2C). In this case, the mat carrier 54 may be placed into a placement opening 52 of an irrigation trough 22 (see FIG. 2B), and the irrigation trough 22 may be inserted into a growing unit 50 of an accommodating space 12 of an apparatus for growing plants 1 (see FIG. 1). In other words, the seed mat 756 may be configured to be accommodated in the accommodating space 12 of an apparatus for growing plants 1. In still other words, the apparatus for growing plants 1 may include an accommodating space 12, which may be configured to accommodate one or more seed mats 756. In this case, the accommodating space 12 may be configured to accommodate one or more seed mats 756 and one or more fertilizer mats, wherein a respective fertilizer mat is arranged on the mat carrier 54 below a respective seed mat 756.

FIG. 8 shows a seed mat including an RFID labelling in accordance with various exemplary embodiments.

As illustrated in FIG. 8, a seed mat 856 in various exemplary embodiments may include an RFID labelling 880. In this case, the RFID labelling 880 may be secured to the carrier substrate 858. The RFID labelling 880 may be embodied for example as an RFID chip or as an RFID tag (in other words, as an RFID transponder; in other words, as an RFID label). As an alternative thereto or in addition, the seed mat 856 may include a QR tag (in other words, a QR label; in other words, a QR labelling) (not illustrated) and/or a barcode tag (in other words, a barcode labelling; in other words, a barcode label) (not illustrated). The RFID labelling 880 and/or the QR labelling and/or the barcode may be secured to the seed mat 856 by means of adhesive bonding, tacking, stapling, clipping and/or sewing. The RFID labelling 880 and/or the QR labelling and/or the barcode may preferably be formed from a hydrophobic material. Alternatively, the RFID label 880 may be packaged in a label composed of a hydrophobic material, which may in turn be secured to the seed mat 856.

The RFID labelling 880 and/or the QR labelling and/or the barcode may have a length in a range of approximately 2 cm to approximately 6 cm, optionally in a range of approximately 2.5 cm to approximately 5 cm, optionally in a range of approximately 3 cm to approximately 4 cm, and may have a width in a range of approximately 0.5 cm to approximately 4 cm, optionally in a range of approximately 1 cm to approximately 3 cm, optionally in a range of approximately 1.5 cm to approximately 2 cm.

Correspondingly, a program sensor of the control unit (reference sign 60, see FIG. 1) of the apparatus for growing plants 1 may be provided as an RFID sensor and/or a QR code sensor and/or a barcode sensor. In other words, the control unit 60 may identify the seeds 870 arranged on the seed mat 856 by means of the RFID signals of the RFID labelling 880 and/or of the QR labelling and/or of the barcode of the seed mat 856. In other words, by means of the RFID labelling 880 and/or QR labelling and/or barcode secured to a specific seed mat 856, the control unit 60 may determine biuniquely the seed mat 856 and the seeds 870 inserted with the seed mat 856 into the accommodating space 12 of the apparatus for growing plants 1. For this purpose, one or more RFID antennas may be connected to the control unit 60. In this case, an RFID antenna may be provided, for example, for each mat carrier onto which a seed mat 856 can be placed.

With the use of an RFID chip as an RFID labelling 880, various data regarding the seeds 870 fixed on the carrier substrate 858 may be stored on the RFID chip. Furthermore, various data regarding the seed mat 856 may additionally be stored on the RFID chip. These data stored on the RFID chip may be, for example, data concerning a name of the seeds 870, a type of the seeds 870, a species of the seeds 870, a manufacturer of the seeds 870, a BATCH number of the seeds 870, a year of manufacture of the seed mat 856 and/or a registration number, for example of the manufacturer and/or of the seller of the seed mat 856, but are not restricted thereto. Furthermore, the data stored on the RFID chip may also be, for example, data concerning climate control data and/or irrigation data and/or illumination data adapted individually to the seeds 870 fixed on the seed mats 856.

As an alternative thereto, the control unit 60 may be configured, after identifying the seeds 870 arranged on the seed mat 856 by means of the RFID signals and/or the QR labelling and/or the barcode of the seed mat 856, to retrieve the climate control data and/or irrigation data and/or illumination data adapted to the respective seeds 870 from a data memory. In this case, the data memory may be provided as an external data memory, preferably by way of an Internet connection provided in the apparatus for growing plants 1. In other words, the control unit 60 may be configured to retrieve corresponding data from the external data memory by means of an Internet connection provided by means of corresponding antennas of the apparatus for growing plants 1. The external data memory may be part of a data cloud in which data and application programs may be stored in a distributed manner and, optionally, redundantly.

It should be noted that in FIG. 8, the seeds 870 on the seed mat 856 are illustrated at irregular distances from one another for the sake of simplicity in the illustration. However, the seed mat 856 is not restricted thereto, but the seeds 870 may also be arranged regularly or at different regular distances on the carrier substrate 858, as described above with reference to FIG. 6A and FIG. 6B.

Moreover, the seed mat 856 provided with the RFID labelling 880 and/or the QR labelling and/or the barcode in various exemplary embodiments may be connected to a fertilizer mat (not illustrated). Furthermore, the seed mat 856 provided with the RFID labelling 880 and/or the QR labelling and/or the barcode may be configured to be stacked.

Furthermore, it should be noted that the materials, sizes, thicknesses and arrangements suitable for the seed mat 856 and the constituents thereof may be the same as those described above with reference to any of FIG. 3 to FIG. 7, and are not repeated here.

FIG. 9 shows an apparatus for growing plants for accommodating a seed mat including an RFID labelling in accordance with various exemplary embodiments. As illustrated in FIG. 9, the apparatus for growing plants 901 includes a cabinet-like housing 910, which is illustrated here from a semifrontal perspective. A door and a front side wall of a base 914 of the housing 910 are omitted in this illustration for the sake of simplicity.

As illustrated in FIG. 9, the apparatus for growing plants 901 may include an accommodating space 912, into which one or more seed mats provided with seeds may be inserted by means of a growing unit 50 illustrated in FIG. 1 and FIG. 2A. In this case, said one or more seed mats may be seed mats 856 which may include an RFID labelling 880 and/or a QR labelling and/or a barcode, as illustrated in FIG. 8.

As is furthermore illustrated in FIG. 9, the apparatus for growing plants 901 may include at least one RFID antenna 982 and/or an RFID sensor 982 and an RFID reader 986 for receiving or reading out RFID signals of the RFID labelling 880. In addition or as an alternative to the RFID antennas 982 and the RFID reader 986, the apparatus 901 may include at least one QR code sensor 983 and/or at least one barcode sensor 984 and corresponding readers 987 which may detect and read out the QR labelling and/or the barcode of the at least one seed mat 856 for the control of the program controller.

By way of example, the control unit 60 may be configured to evaluate all signals of the RFID antennas 982 and/or of the RFID sensors 982, of the RFID reader 986, of the QR code sensors 983, of the barcode sensors 984 and of the corresponding readers 987, thereby to identify the seeds 870 inserted and, by means of the program controller, to define climate control data suitable for said seeds 870 for the purposes of the climate control of the accommodating space 912. In other words, the apparatus 901 may include at least one program sensor, wherein the program sensor is provided as an RFID sensor 982 and/or a QR code sensor 983 and/or a barcode sensor 984 which may detect RFID signals and/or the QR labelling and/or the barcode of the at least one seed mat 856 for the control of the program controller. As a result, the control unit 60 may be configured to produce an interior space climate in the accommodating space 912 adapted to the seeds 870 in the corresponding growing unit 50 by means of the program controller on the basis of the climate control data.

The RFID antennas 982 and/or the RFID sensors 982 (and/or the QR code sensor 983 and/or the barcode sensor 984) may be arranged in side walls 915 of the apparatus 901. The RFID reader 986 (and/or the corresponding other readers 987) may be arranged at a rear side wall 919 of the apparatus 901 or may be arranged in a base 914 of the apparatus 901 in the vicinity of the control unit 60 (not illustrated in FIG. 9). By way of example, a respective RFID antenna 982 may be arranged in a region of the accommodating space 912 corresponding to a lower storey 905a (defined, for example, by means of a growing unit 50 (not illustrated here) accommodated in a lower part of the accommodating space 912) and in a region of the accommodating space 912 corresponding to an upper storey 905b (defined, for example, by means of a growing unit 50 (not illustrated here) accommodated in an upper part of the accommodating space 912). Alternatively, a respective RFID antenna 982 may be arranged in each of the side walls 915 in such a way that each of said one or more seed mats 856 applied on a respective mat carrier 54 (not illustrated in FIG. 9) may be identified individually. In other words, the apparatus 901 may be configured to identify, by means of the RFID antennas 982, seeds 870 and/or plants applied on each of said one or more seed mats 856 placed onto the respective mat carrier 54 in the lower storey 905a and/or in the upper storey 905b, wherein each of the seed mats 856 includes an RFID labelling 880 for this purpose.

Alternatively, the apparatus 901, as described above, in various exemplary embodiments, may furthermore be configured to connect to the Internet by means of WLAN. For this purpose, the apparatus 901 may include a WLAN antenna 989, for example a WiFi antenna. By way of example, the WLAN antenna 989 may be arranged in an upper cover 911 of the apparatus 901. The control unit 60 may additionally be configured to retrieve data stored in an external data memory, for example a cloud, via the Internet by means of the Internet connection. By way of example, the control unit 60 may be configured to retrieve data stored in the cloud regarding the seeds inserted into the accommodating space 912 and/or the plants growing therefrom.

As already explained above with reference to FIG. 8, the control unit 60 may be configured, by means of the RFID antennas 982 and/or RFID sensors 982 and the RFID reader 986, to read and to identify the corresponding RFID labelings 880 inserted into the accommodating space 912 by means of the seed mats 856. Furthermore, the control unit may be configured to retrieve information concerning the seeds 870 applied on the respective seed mat 856 and identified by means of the respective RFID labelling 880 (and/or concerning the plants that are germinated on the respective seed mat 856) from a program memory. By way of example, the control unit 60 may be configured to read out, from the program memory, information regarding the plant type positioned in the accommodating space 912, the exact positioning thereof within the accommodating spaces 912, and a growth phase of the plants. Moreover, in various exemplary embodiments, the control unit 60 may be configured to read out, from the program memory, instructions regarding the interior space climate beneficial to the further growth of the plants on the basis of the read-out information concerning the inserted plant type, the positioning thereof in the accommodating space 912 and the growth phase.

Alternatively or additionally, the control unit 60 may moreover be configured, for example, to retrieve data stored in the cloud regarding the respective requirements of the inserted plant type, the respective growth phase thereof and/or the state thereof with respect to the air temperature, the air humidity, the spectral composition of the light used for illumination, the illumination intensity, the illumination duration and the supply of water and nutrients.

Furthermore, the control unit 60 may be configured to subsequently drive the irrigation apparatus 20, the illumination apparatus 30 and the climate control device 40 on the basis of the climate control data and/or irrigation data and/or illumination data adapted individually to the seeds 870.

By way of example, the control unit 60 may be configured, on the basis of the data retrieved from the cloud, to define controlled variables for the air temperature, the air humidity, the spectral composition of the light used for illumination, the illumination intensity, the illumination duration and the filling of the irrigation troughs and to output them to the climate control device 40, the illumination apparatus 30 and/or the irrigation apparatus 20. Correspondingly, the control unit 60 may be configured to drive the climate control device 40, the illumination apparatus 30 and/or the irrigation apparatus 20 in such a way that the air temperature, the air humidity, the spectral composition of the light used for illumination, the illumination intensity, the illumination duration and/or the filling of the irrigation troughs 22 are/is set in accordance with the specific requirements of the plants positioned and/or growing in the accommodating space 12, 912.

By way of example, the control unit 60 may be configured to drive the irrigation apparatus 20 on the basis of the irrigation data and/or nutrient requirement data adapted individually to the seeds 870 in such a way that an amount of water and/or amount of nutrients and/or nutrient composition beneficial to the germination of the seeds and/or to the growth of the plants are/is fed to the seed mats 856 inserted into the accommodating space 912 and/or to the seeds 870 fixed thereon and/or to the plants growing thereon. Moreover, the control unit 60 of the apparatus for growing plants 901 may be configured to set, by means of the program controller and the climate control device 40 on the basis of the climate control data in the accommodating space 912, an interior space climate adapted to the seeds 870 fixed on the seed mat 856 and/or to the plants growing on the seed mat 856. Furthermore, the control unit 60 of the apparatus for growing plants 901 may be configured, by means of the program controller on the basis of the illumination data, to irradiate the seeds 870 fixed on the seed mat 856 positioned in the accommodating space 912 and/or the plants growing on the seed mat 856 with light of a duration and/or spectral composition (in other words, wavelength composition) beneficial to the germination and/or the growth of the plants, by means of the illumination apparatus 30.

Referring to FIG. 8 again, the seed mat 856 may be configured such that the RFID labelling 880 and/or the QR labelling and/or the barcode may be detachable. In other words, the RFID labelling 880 and/or the QR labelling and/or the barcode may be configured as separable. To put it yet another way, the RFID label 880 and/or the QR labelling and/or the barcode may be configured to be separated from the seed mat 856.

In accordance with the above-described equipment of the seed mat 856 with an RFID labelling 880 and/or a QR labelling and/or a barcode, the method for producing a seed mat, as described above with reference to FIG. 4 and FIG. 5, in various exemplary embodiments, may furthermore include identifying the seed mat 856 by means of an RFID label 880 and/or a QR labelling and/or a barcode. In this case, the RFID labelling 880 and/or the QR labelling and/or the barcode may be secured to the seed mat 856 by means of adhesive bonding, tacking, stapling, clipping and/or sewing. The RFID labelling 880 and/or the QR labelling and/or the barcode may preferably be formed from a hydrophobic material. Alternatively, the RFID label 880 may be packaged in a label composed of a hydrophobic material, which may in turn be secured to the seed mat 856.

In this case, the RFID label 880 and/or the QR labelling and/or the barcode may encode the seeds 870 fixed on the seed mat 856. Furthermore, identifying the seed mat 856 in various exemplary embodiments may be performed by means of an RFID chip 880, wherein the RFID chip 880 may include data concerning a name of the seeds 870, a type of the seeds 870, a species of the seeds 870, a manufacturer of the seeds 870, a BATCH number of the seeds 870, a year of manufacture of the seed mat 856 and/or a registration number, for example of the manufacturer and/or of the seller of the seed mat 856, and/or, furthermore, data concerning climate control data and/or irrigation data and/or illumination data adapted individually to the seeds 870 fixed on the seed mats 856. The tag having the RFID labelling 880 and/or the QR labelling and/or the barcode may include, for example, logos of the manufacturer and/or of the seller and/or the name of the plant and/or a QR code, these indications preferably being printed on.

Using one or more of the seed mats 56 described above (or the seed mats 356, 456, 656, 756 and/or 856 described with reference to FIG. 3 to FIG. 8) and the apparatus for growing plants 1, 901 described with reference to FIG. 1, FIG. 2 and FIG. 9, a method for growing plants may be provided which includes producing one or more seed mats 56 in accordance with a method for producing a seed mat as described above with reference to FIG. 5 and FIG. 8, inserting said one or more seed mats 56 provided with seeds into an accommodating space 12, 912 of the apparatus for growing plants 1, 901, and providing ambient conditions in such a way that the seeds on said one or more seed mats 56 may germinate and plants may grow therefrom, by means of the apparatus 1, 901.

As an alternative thereto, a method for growing plants may be provided which includes producing one or more seed mats 56 (or the seed mats 356, 456, 656, 756 and/or 856 described with reference to FIG. 3 to FIG. 8) in accordance with a method for producing a seed mat 56 as described above with reference to FIG. 5 and FIG. 8, providing first ambient conditions in such a way that the seeds on said one or more seed mats 56 may germinate and plants may grow therefrom, interrupting the growth process by means of suitable second ambient conditions, inserting said one or more seed mats 56, on which plants grow, into an accommodating space 12, 912 of an apparatus for growing plants 1, 901, and providing third ambient conditions in such a way that the plants may continue to grow and bear fruit, if appropriate, by means of the apparatus 1, 901.

In this case, the ambient conditions may concern, for example, an air temperature, an air humidity, a water supply, a nutrient supply, an illumination quality, an illumination intensity and/or an illumination duration, wherein the ambient conditions are not restricted to these parameters.

By means of the first method mentioned above, a user, by means of inserting a seed mat 56 provided with seeds into the accommodating space 12, 912 of the apparatus for growing plants 1, 901, may expose the seeds, for example, firstly to ambient conditions which are favorable for the germination of the seeds. This may mean, for example, that the seed mat 56 is supplied with water by means of the irrigation apparatus 20 in an amount such that the seed mat 56 is wetted, such that the seeds is surrounded by the liquid required for germination. After germination, the control unit 60 may drive the irrigation apparatus 20 in such a way that the seed mats 56 themselves are no longer wetted, but water and nutrients for growing and for possible fruiting and fruit ripening are supplied only to the roots of the germinated grains of seeds. In this case, the control device 60 may drive the illumination apparatus 30 and the climate control device 40 in an analogous manner for obtaining corresponding optimum ambient conditions for the different growth phases of the inserted seeds and/or plants.

By means of the second method mentioned above, by contrast, the user is provided with an opportunity to obtain products ready for harvest within shorter growth phases by seed mats 56 being provided whose seeds, before being delivered to the user, for example, had already been exposed, in a greenhouse, to first ambient conditions, under which the seeds could germinate. In a second section of the method, the germinated seeds then are exposed to second ambient conditions, which interrupt or at least delay further growth, thus giving rise to a time period which may be used, for example, for transport to the user. In a third phase, the user inserts the seed mats 56 with the seeds that have germinated, but are not yet ready for harvest, for example, into the accommodating space 12, 912 of said user's own apparatus for growing plants 1, 901, wherein third ambient conditions are set therein, thereby stimulating further growth of the plants and possible fruiting and fruit ripening to a harvestable state.

However, this second of the methods mentioned above is not restricted to the example explained above, but may, for example, also be carried out by the user himself/herself if the latter removes seeds that have already germinated with the seed mat 56 from said user's apparatus for growing plants 1, 901 and places them in the refrigerator instead, in order to interrupt further growth, while the user goes on holiday, and then in turn, by of inserting the seed mat 56 once again into said user's apparatus 1, 901, may grow harvestable products within a time period that is shorter than a time period that would be required by the total growth process including germination.

In a method for growing plants, the apparatus for growing plants 1, 901 may furthermore identify the seeds fixed on the seed mat 56 by means of a program sensor of a program controller. In this case, the program sensor may be configured as an RFID sensor and/or QR code sensor and/or barcode sensor and may detect RFID signals of the RFID label and/or the QR labelling and/or the barcode of at least one seed mat 56 positioned in the accommodating space 12, 912 of the apparatus 1, 901 for controlling the program controller.

In the method, the program controller may, furthermore, retrieve climate control data and/or irrigation data and/or illumination data adapted individually to the identified seeds from a data memory. In this case, the data memory may be provided as an external data memory. The program controller may retrieve the data from an external data memory by means of an Internet connection.

As an alternative thereto, the apparatus for growing plants 1, 901, in the method, may retrieve data concerning seeds fixed on the seed mat 56 and/or concerning the seed mat 56 from an RFID chip fixed to the seed mat 56. In this case, the data stored on the RFID chip may be data concerning a name of the seeds, a type of the seeds, a species of the seeds, a manufacturer of the seeds, a BATCH number of the seeds, a year of manufacture of the seed mat 56 and/or a registration number, for example of the manufacturer and/or of the seller, of the seed mat 56. Furthermore, the data stored on the RFID chip may be data concerning climate control data and/or irrigation data and/or illumination data adapted individually to the seeds fixed on the seed mats 56.

In yet another alternative thereto, after identifying the seeds arranged on the seed mat 56 by means of the RFID signals and/or the QR labelling and/or the barcode of the seed mat 56, the control unit 60 may retrieve the climate control data and/or irrigation data and/or illumination data adapted to the respective seeds from a data memory. In this case, the data memory may preferably be provided as an external data memory by way of an Internet connection provided in the apparatus for growing plants 1, 901. In other words, the control unit 60 may retrieve corresponding data from the external data memory by means of an Internet connection provided by means of corresponding antennas of the apparatus for growing plants 1, 901. The external data memory may be part of a data cloud in which data and application programs may be stored in a distributed manner and, optionally, redundantly.

For this purpose, the apparatus 1, 901 may include at least one RFID antenna and/or an RFID sensor and an RFID reader, by means of which RFID signals of the RFID labelling may be received and read out in the method. Additionally or alternatively, by means of at least one QR code sensor and/or at least one barcode sensor and corresponding readers, the apparatus 1, 901 may detect and read out the QR labelling and/or the barcode of the at least one seed mat 56 for controlling the program controller.

By way of example, the control unit 60 may read and evaluate all signals of the RFID antennas and/or of the RFID sensors, of the RFID reader, of the QR code sensors, of the barcode sensors and of the corresponding readers, thereby identify the seeds positioned in the accommodating space 12, 912 and retrieve, from a program memory, information concerning the seeds applied on the respective seed mat 56 and identified by means of the respective RFID labelling (and/or concerning the plants that have germinated on the respective seed mat). By way of example, the control unit 60 may read out, from the program memory, information regarding the plant type positioned in the accommodating space 12, 912, the exact positioning thereof within the accommodating space 12, 912 and a growth phase of the plants. Moreover, on the basis of the read-out information concerning the inserted plant type, the positioning thereof in the accommodating space 12, 912 and the growth phase, the control unit 60 may read out instructions regarding the interior space climate that is beneficial to the further growth of the plants from the program memory. Furthermore, the control unit 60, by means of the program controller, may define climate control data suitable for these seeds and/or plants for the purposes of climate control of the accommodating space 12, 912.

In other words, by means of at least one program sensor configured as an RFID sensor and/or a QR code sensor and/or a barcode sensor, the apparatus 1, 901 may detect RFID signals and/or a QR labelling and/or a barcode of the at least one seed mat 56 for controlling the program controller. As a result, by means of the program controller, on the basis of the climate control data, the control unit 60 may adjust an interior space climate adapted to the seeds in the corresponding growth unit 50 in the accommodating space 12, 912.

For this purpose, by means of a respective RFID antenna which may be arranged in a region of the accommodating space 12, 912 corresponding to a lower storey (defined, for example, by means of a growing unit 50 accommodated in a lower part of the accommodating space 12, 912) and in a region of the accommodating space 12, 912 corresponding to an upper storey (defined, for example, by means of a growing unit 50 accommodated in an upper part of the accommodating space 12, 912), the control unit 60 may individually identify each of the one or more seed mats 56 applied on a respective mat carrier 54. In other words, by means of the RFID antennas, the apparatus 1, 901 may identify seeds and/or plants applied and/or growing on each of said one or more seed mats 56 that were placed onto the respective mat carrier 54 in the lower storey and/or in the upper storey, wherein each of the seed mats 56 may have an RFID label for this purpose.

Furthermore, in various exemplary embodiments of the method, the apparatus 1, 901 may connect to the Internet via WLAN by means of a WLAN antenna, for example a WiFi antenna, wherein the WLAN antenna may be arranged, for example, in an upper cover of the apparatus 1, 901. The control unit 60 may moreover retrieve data stored in a cloud via the Internet. By way of example, the control unit 60 may retrieve data stored in the cloud regarding the seeds inserted into the accommodating space 12, 912 and/or the plants growing therefrom. Afterwards, on the basis of the data retrieved from the cloud, the control unit 60 may define controlled variables for the air temperature, the air humidity, the illumination quality, the illumination intensity, the illumination duration and/or the filling of the irrigation troughs and output them to the climate control device 40, the illumination apparatus 30 and/or the irrigation apparatus 20. Correspondingly, the control unit 60 may drive the climate control device 40, the illumination apparatus 30 and/or the irrigation apparatus 20 in such a way that the air temperature, the air humidity, the illumination quality, the illumination intensity, the illumination duration and/or the filling of the irrigation troughs 22 are/is set in accordance with the specific requirements of the plants positioned and/or growing in the accommodating space 12, 912.

Alternatively, the control unit 60 may drive the irrigation apparatus 20, the illumination apparatus 30 and/or the climate control device 40 on the basis of the climate control data and/or irrigation data and/or illumination data adapted individually to the seeds 870.

By way of example, in the method for growing plants, by means of the program controller, on the basis of the climate control data, the apparatus 1, 901 may set an interior space climate adapted to the seeds fixed on the seed mat 56 and/or with the plants growing on the seed mat 56 in the accommodating space 12, 912. Moreover, by means of the program controller, on the basis of the irrigation data of the seed mat 56, the apparatus 1, 901 may supply water and nutrients in an amount and composition adapted to the seeds fixed on the seed mat 56 and/or with the plants growing on the seed mat 56. Furthermore, by means of the program controller controlling the illumination apparatus 30, on the basis of the illumination data, the apparatus for growing plants 1, 901 may emit light with a wavelength composition (in other words, spectral composition) adapted to the seeds fixed on the seed mat 56 and/or to the plants growing on the seed mat 56, and for a duration adapted to the seeds fixed on the seed mat 56 and/or to the plants growing on the seed mat 56.

Accordingly, the method for growing plants in the apparatus 1, 901 may furthermore include supplying water and/or nutrients to the irrigation troughs 22. In this case, the one or more irrigation troughs 22 that were inserted into the accommodating space 12, 912 of the apparatus may be filled in such a way that moisture and/or nutrients are/is fed to a sufficient extent to the seeds fixed on the seed mats 56 arranged above said irrigation troughs and/or the plants growing on the seed mats 56.

By way example, the irrigation troughs 22, above which seed mats 56 with seeds that have not yet germinated are arranged, may be filled in such a way that the one or more seed mats 56 placed on the mat carrier 54 are wetted in such a way that enough moisture for germination is supplied to the grains of seeds. Alternatively, the seed mats 56 having dry seeds may be wetted by the user by means of a spray bottle or under the faucet before they are inserted into the accommodating space 12, 912 of the apparatus 1, 901 and placed onto the mat carrier 54.

On the other hand, the irrigation troughs 22, above which seed mats 56 are arranged on which the seeds have already germinated and on which the seedlings or plants growing from the seeds have roots, may be filled in such a way that water and nutrients are supplied only to the roots. In this case, the irrigation troughs 22 may be filled only to an extent such that the seed mats 56 arranged above said irrigation troughs are not wetted themselves, with the result that formation of mold in the seed mats 56 may be avoided.

Overall, the exemplary embodiments provided here of the seed mats for insertion into an apparatus for growing plants may ensure that seeds are provided in such a way that plants, such as, for example, herbs, vegetables, fruit and salad, may be grown from seeds. With the aid of the seed mats described herein, the cultivation of the plants may thereby be made possible on a scale which may also be realized in modern kitchens. As a result, by means of the present seed mats, the average consumer is offered an opportunity to grow herbs, salads, vegetables or fruit in an apparatus for growing plants, and hence, to be able to add fresh ingredients to his/her menu in accordance with his/her personal preferences. In this case, on the one hand, a desired quality may be ensured and, on the other hand, the effort required may be limited to a measure adapted to modern professional life.

In particular, by means of the provided exemplary embodiments of the seed mats and the corresponding equipment of the apparatus for growing the plants growing on the seed mat, it is ensured that, by means of a corresponding identification of the seed mat, the seeds applied thereon may be identified and information regarding the ambient conditions beneficial to the germination and growth of these specific plants positioned in the accommodating space of the apparatus at a specific point of time may be retrieved. The ambient conditions may then be set in the apparatus for growing plants in accordance with the cultivated plant types and the state thereof, for example the growth progress thereof, by means of the climate control device, the irrigation apparatus and/or the illumination apparatus.

Providing all the constituents of the seed mats, such as, for example, carrier substrate, adhesive and coating layer, made from preferably organic materials ensures that the seed mats are fully compostable and therefore environmentally friendly. The described possibilities for configuration of the identification of the seed mats as constituents separable therefrom may furthermore provide a simple possibility for feeding the organic carrier substrate of the seed mat including the plant residues possibly remaining thereon to a place for collection of recyclable materials, e.g. the collection of organic waste. The problem—important primarily in towns/cities—of additional residual waste arising may be avoided as a result.

The particular configuration of the seed mats provided in various exemplary embodiments with an optional coating layer additionally ensures that, in particular, seeds having relatively large grains of seeds may be securely fixed on the seed mats and favorable conditions for the germination of the seeds may be set. Furthermore, it is possible to provide substrate dimensions that are ideal, respectively, for different plant types in the form of seed mats of different sizes and thicknesses, as presented herein, such that plants which may be cultivated in a kind of dense carpet, such as, for example, herbs or salads, may be harvested in large volumes, while plants that thrive better in solitary form, such as, for example, tomatoes and strawberries, have enough room to be able to develop large and ideally ripe fruit by virtue of optimum supply of light.

Last but not least, the configuration of the seed mats in stackable form as provided in various exemplary embodiments ensures, both for the retail sector and for the end consumer, simple transport to the end customer and stock keeping adapted to consumption. This makes it possible, in particular for the user, to be supplied with fresh products independently, without having to rely here on short-term subsequent purchase possibilities.

The provision of the seed mats in accordance with the exemplary embodiments described herein thus makes it possible for the consumer to grow fresh useful plants and thus fresh products for a varied menu in a simple manner with the consumer's own, even small, budget, and here relieves the consumer of the need himself/herself to provide seeds and a bulky planting substrate, such as, for example, fresh planting soil. Moreover, the seed mats provided enable handling of the seeds and the plants without producing dirt to a relatively great degree. The seed mats presented here ensure, in particular, simple handling both of the seeds and of the planting substrate, both being adapted to one another for a best possible manageability with regard to the size and configuration of the seed mat and with regard to the seeds applied thereon.

1. A seed mat for insertion into an apparatus for growing plants, the seed mat comprising:
a carrier substrate; and
seeds;
wherein the seeds are fixed on the carrier substrate by an adhesive.

2. The seed mat of claim 1,
wherein the carrier substrate is formed from an organic material,
wherein the carrier substrate, has a water absorption capacity in a range of approximately 3500 cm³ to approximately 5000 cm³ per square meter.

3. The seed mat of claim 1,
wherein the carrier substrate is formed from a material selected from a group consisting of:
jute;
hemp;
rock wool;
cotton;
cellulose;
viscose;
Jiffy® Vitro-Plug™; and
Oasis® Floral Foam.

4. The seed mat of claim 1,
wherein the seeds comprise at least one of a group consisting of:
seeds of salad;
seeds of herbs;
seeds of fruit;
seeds of vegetables;
seeds of mushrooms; and
seeds of mushroom mycelia.

5. The seed mat of claim 1, further comprising:
at least one of an RFID labelling or a QR labelling or a barcode.

6. The seed mat of claim 5,
wherein the at least one of RFID labelling or the QR labelling or the barcode encodes the seeds fixed on the seed mat.

7. The seed mat of claim 5,
wherein the RFID labelling is embodied as an RFID chip.

8. The seed mat of claim 7,
wherein the RFID chip comprises at least one of data regarding the seeds fixed on the seed mat or data regarding the seed mat.

9. An apparatus for growing plants, the apparatus comprising;
an accommodating space for accommodating one or more seed mats, at least one of the one or more seed mats comprising:
a carrier substrate; and
seeds;
wherein the seeds are fixed on the carrier substrate by an adhesive.

10. A method of manufacturing a seed mat, the method comprising:
applying an adhesive on a carrier substrate;
applying seeds on the carrier substrate provided with the adhesive; and
fixing the seeds by the adhesive on the carrier substrate.

11. The method of claim 10,
wherein the carrier substrate is formed from an organic material.

12. The method of claim 10,
wherein the carrier substrate is formed from a material selected from a group consisting of:
jute;
hemp;
rock wool;
cotton;
cellulose;
viscose;
Jiffy® Vitro-Plug™; and
Oasis® Floral Foam.

13. The method of claim 10,
wherein applying the adhesive on the carrier substrate comprises:
applying the adhesive on the carrier substrate by one or more rollers;
applying the adhesive on the carrier substrate by a spraying system; or
applying the adhesive on the carrier substrate by one or more brushes;
wherein applying seeds on the carrier substrate provided with the adhesive comprises:
applying the seeds on the moist adhesive;
wherein the seeds consist of seed grains; and
wherein the seed grains are scattered or individually placed precisely at a specific position.

14. The method of claim 10, further comprising:
identifying the seed mat by at least one of an RFID labelling or a QR labelling or a barcode.

15. The method of claim 14,
wherein at least one of the RFID labelling or the QR labelling or the barcode encodes the seeds fixed on the seed mat.

16. The method of claim 14,
wherein the RFID labelling is embodied as an RFID chip.

17. The method of claim 16,
wherein the RFID chip comprises at least one of data regarding the seeds fixed on the seed mat or data regarding the seed mat.

18. A method for growing plants, the method comprising:
manufacturing one or more seed mats, at least one of the one or more seed mats comprising:
a carrier substrate; and
seeds;
wherein the seeds are fixed on the carrier substrate by an adhesive;
inserting said one or more seed mats provided with seeds into an accommodating space of an apparatus for growing plants; and
providing ambient conditions in such a way that the seeds on said one or more seed mats may germinate and plants may grow therefrom, by the apparatus; or
providing first ambient conditions in such a way that the seeds on said one or more seed mats may germinate and plants may grow therefrom;
interrupting the growth process by suitable second ambient conditions;
inserting said one or more seed mats, on which plants grow, into an accommodating space of an apparatus for growing plants; and
providing third ambient conditions in such a way that the plants may continue to grow and bear fruit, if appropriate, by the apparatus.

19. The method of claim 18,
wherein the ambient conditions refer to at least one of a group consisting of:
an air temperature;
an air humidity;
a water supply;
a nutrient supply;
an illumination quality;
an illumination intensity; and
an illumination duration.

20. The method of claim 18,
wherein the apparatus for growing plants identifies the seeds fixed on the seed mat by a program sensor of a program controller.
